(19) United States
(12) Patent Application Publication
(10) Pub. No.: US 2026/0141446 A1
(43) Pub. Date: May 21, 2026

(54) TRUTH-BASED, SYNTHETIC, PARTIAL-ENTITY KNOWLEDGE SOURCING AND TRADEABLE ASSET CREATION BASED THEREON

(71) Applicant: Bank of America Corporation, Charlotte, NC (US)

(72) Inventors: Jacquelyn Vuong, Tenafly, NJ (US); Joel Hodes, New York, NY (US); Gregory Sherman, Pelham (NY); Alexander Lloyd Kallmann, New York, NY (US); Soofian Zuberi, New York, NY (US)

(21) Appl. No.: 18/953,462

(22) Filed: Nov. 20, 2024

(51) Int. Cl. G06Q 40/04; G06Q 30/0202

(52) U.S. Cl. CPC G06Q 40/04; G06Q 30/0202

(57) ABSTRACT

A method for truth-based, synthetic, partial-entity knowledge sourcing and tradeable asset creation based thereon, is provided. The method may receive a request to transact a long position or a short position with respect to a performance of a selected aspect of a larger entity. The method determines, using artificial intelligence (“AI”) running on a processor, a set of issuance characteristics. The issuance characteristics support the request to transact the long position or short position. The method data-mines historic information to retrieve legacy data representative of the set of issuance characteristics. The data-mining determines whether the set of issuance characteristics supports the request to transact. The method tests the legacy data to determine whether the issuance characteristics support the request to transact. In response to a determination that the issuance characteristics support the request, the method prompts the user to transact the requested long position or the requested short position.

### BACKGROUND OF THE DISCLOSURE

A tracking stock is a special equity offering issued by a parent company. The tracking stock tracks the performance of a particular segment or division within the company. Typically tracking stocks trade separately from the parent entity's stock. Tracking stocks allow larger companies to isolate the financial performance of a higher growth segment. In addition, tracking stocks give investors the ability to gain exposure to a specific aspect of a larger company's business (for example, the exclusively electric car business within an automobile manufacturer.)

Absent the corporation issuing a tracking stock, however, it is currently not possible to offer the tracking stock directly.

It would be desirable to provide truth-based, synthetic, partial-entity knowledge sourcing.

It would be further desirable to base the creation of tradeable assets on the truth-based, synthetic, partial-entity knowledge sourcing.

### SUMMARY OF THE DISCLOSURE

The disclosure relates to a third party sourcing a portion of an entity's information and building thereupon.

Systems, methods, and apparatus are provided for synthesizing a derivative or structured note based on the hypothetical performance of a synthetic tracking stock (“STS”).

A system for administering truth-based, synthetic, partial-entity knowledge sourcing and tradeable asset creation based thereon, is provided. Such a system may include an application programming interface (“API”). The API may be operable to receive a request to transact a long position or a short position with respect to a performance of a selected aspect of a larger entity.

The system may also include a processor. The processor may be operable to run artificial intelligence (“AI”). The AI may be operable to determine a set of issuance characteristics. The set of issuance characteristics may, in certain embodiments, be required to support the request to transact the long position or short position. AI may preferably analyze existing offerings and determine which issuance characteristics are necessary and/or relevant to support the request. Such analysis may analyze the nature of the request and, based thereon, generate a set of issuance characteristics that at least provisionally support such a request.

The system may also include a database for storing historic information for providing responses to data-mining by the processor. The responses may correspond to legacy data representative of the set of issuance characteristics. The responses may provide a basis upon which to determine whether the set of issuance characteristics are capable of supporting the request to transact the long position or short position.

In some embodiments, the processor may be further operable to test the legacy data of the set of issuance characteristics. The testing may be used to determine whether the issuance characteristics support the request to transact the long position or the short position. Upon a failure of such a test, the system may provide feedback to the AI system for modifying the set of issuance characteristics.

In response to a determination that the issuance characteristics support the request to transact the long position or the short position, the system may prompt a user, in communication with a display screen associated with a computing device associated with a user, to transact the requested long position or the requested short position.

In certain embodiments, the AI may be further operable to cull information from a historical set of issued securities to determine which of the set of issuance characteristics are necessary and sufficient to receive and transact a long or short position with respect to the performance of a selected aspect of the larger entity.

It should be noted that the AI may be further operable to revise, based on the information culled from the historical set of issued securities, the set of issuance characteristics. Such revision may include removing one of the issuance characteristics. Such revision may include adding an additional issuance characteristic.

A processor associated with the system may be further operable to transact a transaction corresponding to the long or short position using a smart contract deployed on a blockchain.

The processor may be yet further operable to maintain a viability of the prompting for a pre-determined period of time.

In certain embodiments, the processor may be operable to prompt a selected group of users. Each of the selected group of users may be identified in the request to transact a short position or a long position.

The processor may be further operable to make a market in a metric related to the performance of the selected aspect of the larger entity. When making a market, the processor may be further operable to present, to the selected group of users, a market bid price and a market offer price for the metric.

The processor may yet further be operable to post a tradeable option. The tradeable option may be based, at least in part, on the performance of the selected aspect of the larger entity.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus in accordance with principles of the disclosure;

FIG. 2 shows illustrative apparatus in accordance with principles of the disclosure;

FIG. 3 shows an exemplary derivatives list as derived from an STS;

FIG. 4 shows an illustrative flow diagram in accordance with the principles of the disclosure;

FIG. 5 shows an illustrative schematic diagram in accordance with the principles of the disclosure;

FIG. 6 shows another illustrative schematic diagram in accordance with the principles of the disclosure; and

FIG. 7 shows yet another illustrative schematic diagram in accordance with the principles of the disclosure.

### DETAILED DESCRIPTION OF THE DISCLOSURE

This disclosure involves synthesizing a derivative or structured note based on the hypothetical performance of a synthetic tracking stock (“STS”).

The hypothetical performance preferably approximates the cash flows that would arise if a tracking stock with respect to the specific aspect of the larger company's business was outstanding, available and tradeable.

Furthermore, STS derivatives, according to the disclosure, preferably enable expression of long or short term views on performance and/or metrics of the selected aspect of the larger entity's business.

An STS according to the disclosure may pay dividends for each unit value. These dividends may be paid out, preferably in a fixed fashion, during the lifetime of the unit value ownership.

At the conclusion of the life of the STS, one possible valuation of the STS may be characterized with the following component parts. The STS may be characterized as the product of 1) a reported (e.g., 10K or 10Q valuation) per share annualized earnings or revenue associated with the underlying line of business that supports the specific aspect of the larger company's business coupled to the STS and 2) a multiple that represents the valuation multiple of publicly traded comparable lines of business or is otherwise gauged to produce an estimate of per share value of that business line. This multiple could be fixed, or recalculated periodically. The calculation of the multiple is preferably constructed to be in accordance with current market multiples.

In one example according to the present disclosure, a client may pay $50 million dollars (“mm”) for a structured note. The note may mature in a pre-determined amount of time such as five years. At the end of the five years, the structured note may pay the product of 1) the hypothetical per share cash flow on an STS on the ACME Cloud Services business. Cash flow on the STS may be defined as a fixed dividend per share for the life of the note and a final value of 3.3 times the 2029 per share revenue of the ACME Cloud Services business as reported in the 2029 ACME 10K. The 3.3K could be fixed, or adjusted at maturity via a formula intended to reflect then-prevailing market multiples. In some embodiments, the formula may be dynamic, such that the formula is operable to adapt to relevant change in market conditions.

In another example, a client may enter into a six-month swap on an STS for ABC Streaming Operations under which the client receives the hypothetical performance of the STS. Performance of an exemplary STS includes a fixed dividend and a final payment of five times the latest reported 10Q revenue (preferably annualized) of ABC's Streaming Operations.

In certain embodiments of the disclosure, the embodiments may involve a Software as a Service (“SaaS”) front-end engine. Such an engine may preferably support user involvement of the STS creation process. For example, the SaaS module may prompt a user to enter a desired and specific aspect of a larger company's business to determine if the specific aspect is outstanding, available and can be converted to be tradeable.

Following a determination that the specific aspect of the larger company's business is determined outstanding, available and can be converted to be tradeable, the embodiments may generate a set of characteristics related to the creation of the STS.

The table below sets forth exemplary characteristics for an STS corresponding to the streaming division of the fictional Fantasia Company:

TABLE 1

| | |
|---|---|
| Parent Corporation Ticker | FAN |
| Parent Corporation Name | Fantasia Company |
| Underlying Division | Home Entertainment |
| Underlying Industry Sector | Communications |
| Underlying Industry Group | Internet |
| Underlying Industry Sub-Group | Internet Content - |
| | Entertainment |
| Instrument Name | Fantasia Home Entertainment |
| | Synthetic Tracking Stock |
| Instrument ID | FANHE .1 |
| Model | STS |
| Instrument Type | Synthetic Tracking Stock |
| Valuation Multiple | 25.3 |
| Dividend | Y |
| Country Code | US |

It should be noted that the above-listed characteristics may preferably be available, or derivable, from public information. Such characteristics, therefore, add the synthetic—truth-based—aspect to the embodiments set forth herein. Furthermore, these characteristics promote the ability to derive multiples for use with maturity formulas for STS products.

In some embodiments, creation and trading of the STS may be conducted among a limited-member group of trading entities. Such a group, referred to herein in the alternative as a consortium, may preferably participate in confidential trading, preferably only among the consortium.

In certain embodiments, such trading may occur preferably independently of making any market impact. This is true at least because such trading may be conducted on a private network independent of the public network for trading. This is true also because the STS preferably exists independently of the parent entity and, as such, has no effect, or substantially no direct effect, on trading of the parent entity.

In certain embodiments, consummation of a transaction involving an STS may invoke a dynamic, electronically-based, agreement such as a smart contract on a blockchain.

For further background regarding using smart contracts to support transactions according to the disclosure, crypto transactions on blockchains, which may be invoked according to the system and methods according to the disclosure are explained in the following paragraphs. Crypto transactions are stored as digital entries in a distributed public ledger. The distributed public ledger may be a blockchain. Cryptocurrency utilizes the blockchain to process the crypto transactions. A blockchain is a distributed database of records or public ledger of all transactions or digital events that have been executed and shared among participants.

Each transaction or digital event in the distributed database of records or public ledger may be verified by a majority of participants included in the system. Once a transaction or digital event is executed, it can never be erased. Therefore, the blockchain contains a certain and verifiable record of every single transaction.

Blockchain technology has the ability to enable a distributed record of every online transaction that can be verified at any time in the future. Blockchain technology does not compromise the privacy of digital assets and the parties involved because the blocks, included on the chain, either do not include private data or include an encrypted version of private data.

Methods and systems according to the disclosure may leverage smart contracts. The smart contracts may invoke crypto transactions, as well as cryptocurrency, to involve numerous parties to a transaction involving the participants in a trade involving the STS.

The methods may include receiving, at a unified payment gateway, a transaction data packet. The unified payment gateway may be a payment gateway that is configured to receive, process and approve, or otherwise transact, pending transactions.

The unified payment gateway may be included as part of a multidimensional (including crypto for use with blockchain) transaction/payment (“MTP”) network. The MTP network may be a decentralized network. The MTP network may be a distributed network. The MTP network may be a blockchain. The MTP may include one or more nodes. The one or more nodes may be computing devices, peripheral devices and/or any other suitable network devices. The computing devices may include desktop computers, laptops, tablets, smartphones, personal device assistants (“PDAs”), mainframe computers and/or any other suitable computing devices.

The transaction data packet may include data relating to a pending transaction. The pending transaction may be executed between a sender node and a receiver node. The sender node may be a node associated with a requester of the transaction. The receiver node may be a node associated with a receiver of the transaction. The sender node may be included in the MTP network. The sender node may not be included in the MTP network. The receiver node may be included in the MTP network. The receiver node may not be included in the MTP network.

The transaction data packet may include data relating to sender node identification. Data relating to sender node identification may include an alphanumeric identification (“ID”) number, an internet protocol (“IP”) address and/or any other data that may be used to identify the sender node. The identification may be used to differentiate the sender node from other nodes. The transaction data packet may include data relating to receiver node identification. Data relating to receiver node identification may include an alphanumeric ID number, an IP address and/or any other data that may be used to identify the receiver node. The identification may be used to differentiate the receiver node from other nodes.

The transaction data packet may include data relating to the pending transaction. Data relating to the pending transaction may include personal/confidential information related to the sender node or the receiver node. Personal/confidential information may include information such as sender node or receiver node financial information, sender node or receiver node authentication information and/or any other suitable non-public sender node or receiver node information. Data relating to the pending crypto transaction may include a location at which the transaction was initiated, a time at which the transaction was initiated, an amount of resources that was determined to be traded through the transaction, and/or any other suitable data relating to the transaction.

Validating the final-approval of a transaction may include creating a smart contract. A smart contract may include a computer code that has the power to execute and enforce itself, based on a series of programmed parameters. The smart contract may be created using a node consensus validator. The smart contract may include the sender node identification. The smart contract may include the receiver node identification. The smart contract may include the final-approver node identification. The smart contract may include a non-fungible token (NFT). The smart contract may include a set of rules to use in order to validate the smart contract.

The set of rules may include a set of parameters that need to be met to enable the transaction. The set of rules may be a set of predetermined conditions that may enable the smart contract to execute and enforce itself when the conditions are met. Validating the smart contract may include solving the set of rules. Solving the set of rules may include meeting all the specified parameters. Solving the set of rules may enable the smart contract to self-execute and self-enforce itself. Enabling the smart contract to execute and enforce itself may trigger the pending transaction to be approved and added to the MTP network. The smart contract may serve as a record of the approved transaction and the nodes that were involved in approving the transaction.

In response to validating the smart contract the methods may include transacting the pending transaction. After approving the transaction, the methods may include storing the transaction in the MTP network as a transacted transaction. Storing the transaction may include creating a block. The block may include the pending transaction. Storing the transaction may include adding the block to the MTP network. In response to approving and storing the transaction, resources may be exchanged between the receiver node and sender node as specified by the transaction.

In some embodiments, the methods may include receiving, processing, verifying, approving and storing any suitable pending transaction from any suitable trading platform.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods. Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

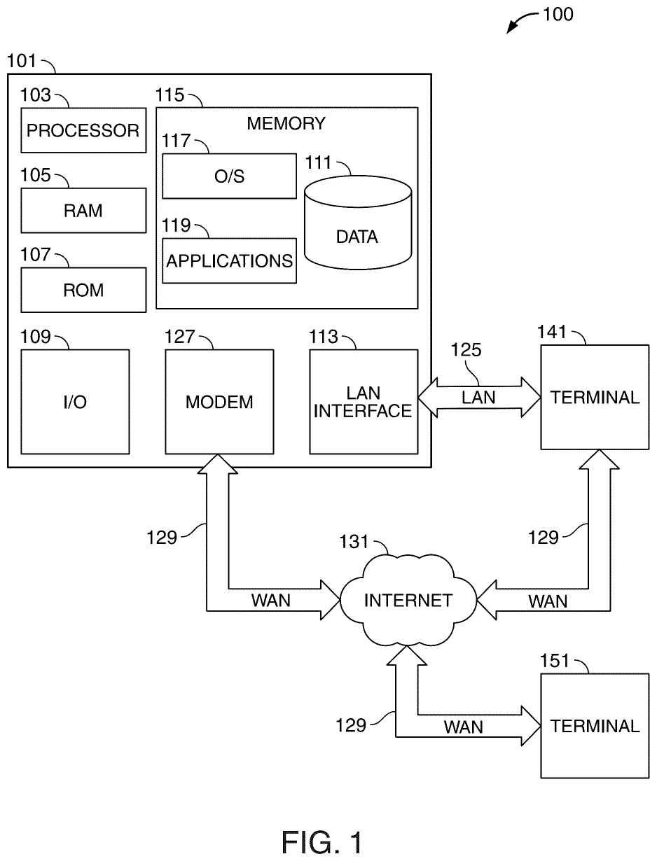

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute all software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

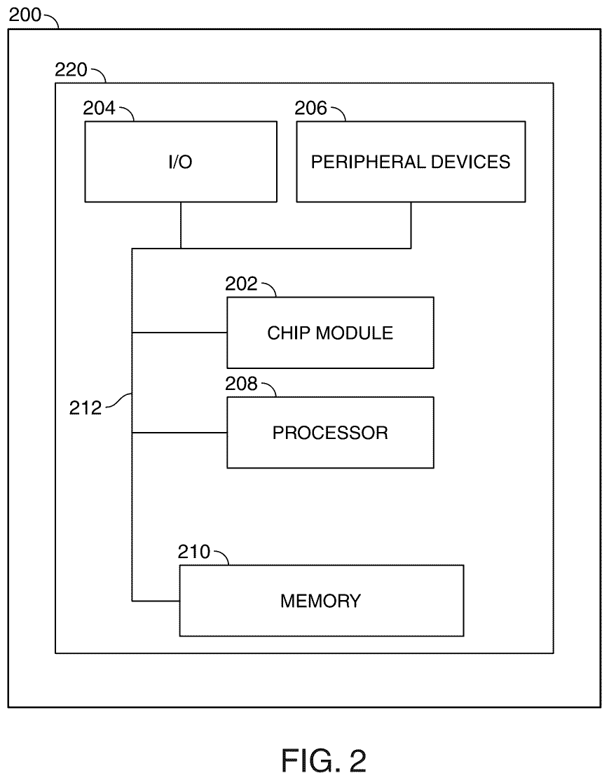

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

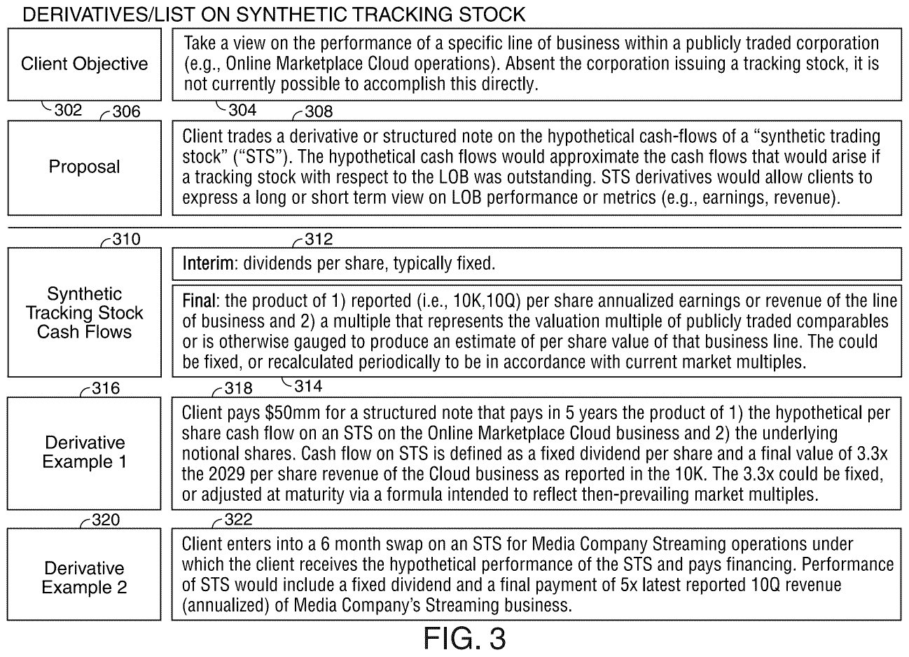

FIG. 3 shows an exemplary derivatives list as derived from an STS. At 302, a client objective is shown. At 304—the client objective describes taking a view on the performance of a specific line of business within a publicly traded corporation (e.g., Online Marketplace Cloud operations of a full-service media entity.) Absent the corporation issuing a tracking stock, it is not currently possible to take this view.

At 306, a system proposal is shown. In the exemplary system proposal, a client trades a derivative or structure note on the hypothetical cash-flows of a “synthetic trading stock” STS. The hypothetical cash flows would approximate the cash flows that would arise if a tracking stock with respect to the relevant line of business (LOB) was outstanding.

STS derivatives preferably enable clients to express a long or short term view on LOB performance or metrics (e.g., earnings, revenue, etc.).

The instantiation of the derivatives is shown at portions of FIG. 3 indicated by lead lines 310-322.

At 310, STS cash flows are shown. At 312 and 314, two stages of possible cash flows are set forth. At 312, in an interim stage of development, dividends per share, which may preferably be fixed during the duration of the STS, are contemplated. In a final stage of development, the product of 1) reported per share annualized earnings or revenue of the line of business and 2) a multiple that represents the valuation multiple of publicly-traded comparable securities or is otherwise gauged to produce an estimate of per share value of that business line may produce a simulated STS cash flow.

At 316, a first derivative example 1 is shown. Specifically, at 318, a client pays $50 million (mm) for a structured note that pays in 5 years the product of 1) the hypothetical per share cash flow on an STS on the Online Marketplace Cloud business and 2) the underlying notional shares of the STS. Cash flow on STS may be defined as a fixed dividend per share and a final value of 3.3× the 2029 per share revenue of the Cloud business as reported in the company 10K. The 3.3× could be fixed, or adjusted at maturity via a formula intended to reflect then-prevailing market multiples.

At 320, a first derivative example 1 is shown. Specifically, at 322, a client enters into a 6 month swap on an STS for Media Company Streaming operations under which the client receives the hypothetical performance of the STS and pays financing. Performance of STS would preferably include a fixed dividend and a final payment of 5× latest reported 10Q revenue (annualized) of Media Company's Streaming business.

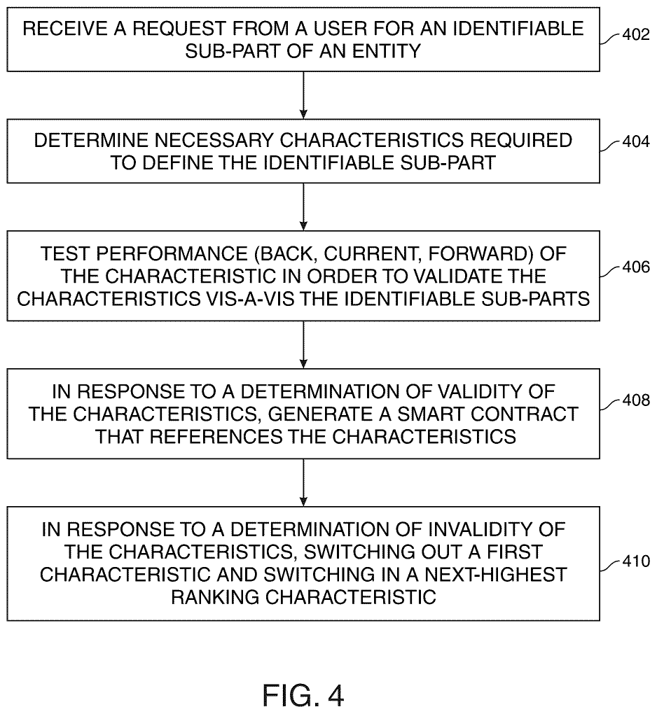

FIG. 4 shows an illustrative flow diagram in accordance with the principles of the disclosure. At 402, a system according to the disclosure receives a request from a user for an identifiable sub-part of an entity. At 404, the system may determine necessary, or preferable, characteristics for defining the identifiable sub-part of the entity.

At 406, test performance may be invoked (back, current, or forward (projected)) of the one or more characteristics in order to validate the characteristics vis-à-vis the viability as a tradeable instrument the identifiable sub-part.

In response to a determination of validity of the characteristics, the system may generate a smart contract that references one or more of the validated characteristics.

In response to a determination of invalidity of one or more of the characteristics, the system may switch out a first characteristic (or multiple characteristics) to a next-highest ranking characteristic (or characteristics).

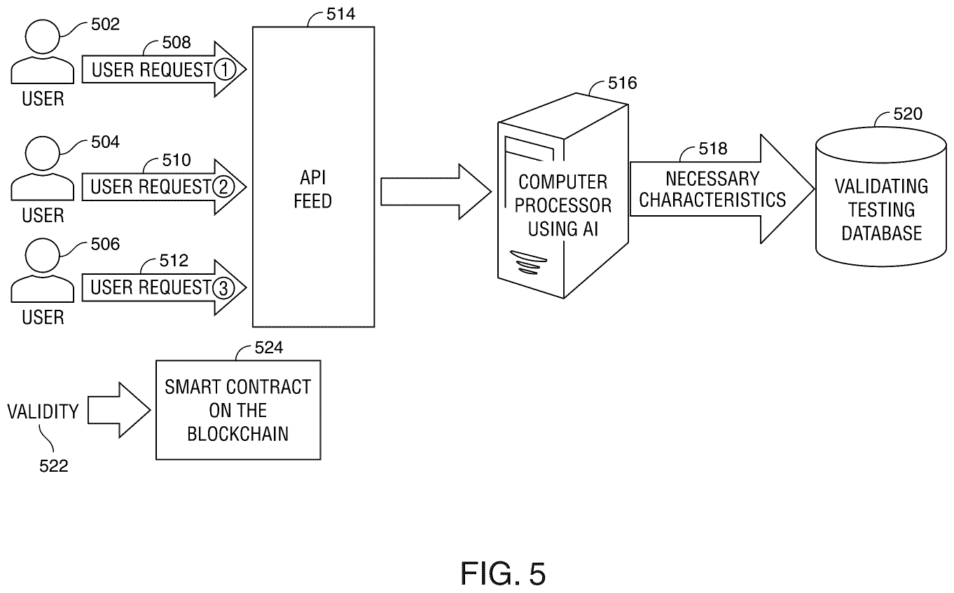

FIG. 5 shows an illustrative schematic diagram in accordance with the principles of the disclosure. Users are shown at 502, 504 and 506. Respective user requests are shown at 508, 510 and 512. Each of user requests 508, 510 and 512 are directed, via API feed 514, to a computer processor using artificial intelligence (AI) 516.

At 518, computer processor using AI 516 produces one or more necessary characteristics for creating the STS. At 520, computer processor using AI 516 validates proposed necessary characteristics in testing database 520.

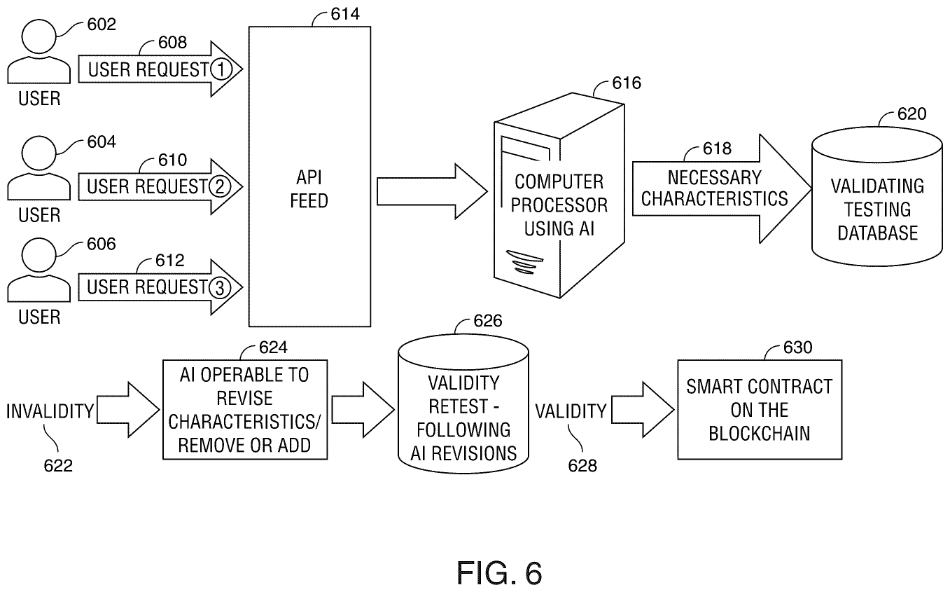

FIG. 6 shows another illustrative schematic diagram in accordance with the principles of the disclosure. FIG. 6 elements 602, 604, 606, 608, 610, 612, 614, 616, 618 and 620 substantially correspond to elements 502, 504, 506, 508, 510, 512, 514, 516, 518 and 520 shown in FIG. 5.

FIG. 6 also shows that in the case of an invalidity determination, as shown at 622 of one or more of the characteristics provided at 616, the AI may be operable to revise characteristics by removing one or more characteristics from the list and/or adding one or more characteristics to the list of necessary characteristics.

At 626, the system may retest validity following AI revisions to, and/or replacements of, the characteristics. Finally, following a finding of validity of the characteristics at 628, the system may preferably implement, in certain embodiments, a smart contract on the blockchain at 630. Such a smart contract may preferably be user-accessible such that participants in transactions involving the STS may interact directly with the smart contract, or mechanisms associated with the smart contract, absent other interfaces.

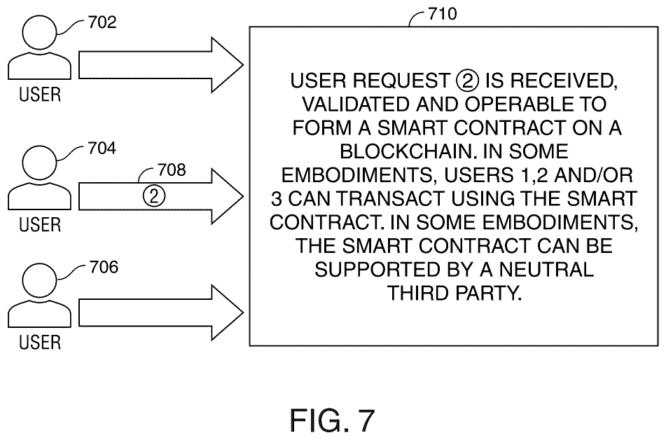

FIG. 7 shows yet another illustrative schematic diagram in accordance with the principles of the disclosure. Users are shown at 702, 704 and 706.

At 710, user request (2) is received, validated and determined to be operable to form a smart contract on a blockchain. In some embodiments, users 1, 2 and/or 3 can transact using the smart contract. In some embodiments, the smart contract can be supported by a neutral third party.

Thus, methods and apparatus for a truth-based, synthetic, partial-entity knowledge sourcing and tradeable asset creation based thereon are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for truth-based, synthetic, partial-entity knowledge sourcing and tradeable asset creation based thereon, said method comprising:
receiving, via an application programming interface (“API”), a request to transact a long position or a short position with respect to a performance of a selected aspect of a larger entity;
determining, using artificial intelligence (“AI”) running on a processor, a set of issuance characteristics, the set of issuance characteristics that are required to support the request to transact the long position or short position;
data-mining, using the processor, a database of historic information in order to retrieve legacy data representative of the set of issuance characteristics to provide a basis upon which to determine whether the set of issuance characteristics are capable of supporting the request to transact the long position or short position;
testing, using the processor, the legacy data of the set of issuance characteristics to determine whether the issuance characteristics support the request to transact the long position or the short position;
in response to a determination that the issuance characteristics support the request to transact the long position or the short position, prompting, using the processor in communication with a display screen associated with a computing device associated with a user, the user to transact the requested long position or the requested short position.

2. The method of claim 1, wherein the AI is further operable to cull information from a historical set of issued securities to determine which of the set of issuance characteristics are necessary and sufficient to transact a long or short position with respect to the performance of a selected aspect of the larger entity.

3. The method of claim 2, wherein the using the AI is further operable to revise, based on the information culled from the historical set of issued securities, the set of issuance characteristics, wherein said revising comprises removing one of the issuance characteristics.

4. The method of claim 2, wherein the AI is further operable to revise, based on the information culled from the historical set of issued securities, the set of issuance characteristics, wherein said revising comprises adding an additional issuance characteristic.

5. The method of claim 1 further comprising using the processor to transact a transaction corresponding to the long or short position using a smart contract deployed on a blockchain.

6. The method of claim 1 further comprising maintaining a viability of the prompting for a pre-determined period of time.

7. The method of claim 1, wherein the prompting comprises prompting a selected group of users.

8. The method of claim 7, wherein each of the selected group of users is identified in the request to transact.

9. The method of claim 7, wherein the prompting further comprises making a market by presenting a bid price and an offer price to the selected group of users for the long position or the short position with respect to the performance of the selected aspect of the larger entity.

10. The method of claim 1, wherein the prompting further comprises posting a tradeable option by posting a bid price and an offer price for the performance of the selected aspect of the larger entity.

11. A system for administering truth-based, synthetic, partial-entity knowledge sourcing and tradeable asset creation based thereon, said system comprising:
an application programming interface (“API”), the API operable to receive a request to transact a long position or a short position with respect to a performance of a selected aspect of a larger entity;
a processor, the processor operable to run artificial intelligence (“AI”), the AI operable to determine a set of issuance characteristics, the set of issuance characteristics that are required to support the request to transact the long position or short position;
a database for storing historic information for providing responses to data-mining by the processor, said responses corresponding to legacy data representative of the set of issuance characteristics, said responses for providing a basis upon which to determine whether the set of issuance characteristics are capable of supporting the request to transact the long position or short position;
wherein the processor is further operable to:
test the legacy data of the set of issuance characteristics, said testing for determining whether the issuance characteristics support the request to transact the long position or the short position; and
in response to a determination that the issuance characteristics support the request to transact the long position or the short position, prompt, in communication with a display screen associated with a computing device associated with a user, the user to transact the requested long position or the requested short position.

12. The system of claim 11, wherein the AI is further operable to cull information from a historical set of issued securities to determine which of the set of issuance characteristics are necessary and sufficient to transact a long or short position with respect to the performance of a selected aspect of the larger entity.

13. The system of claim 12, wherein the using the AI is further operable to revise, based on the information culled from the historical set of issued securities, the set of issuance characteristics, wherein said revising comprises removing one of the issuance characteristics.

14. The system of claim 12, wherein the AI is further operable to revise, based on the information culled from the historical set of issued securities, the set of issuance characteristics, wherein said revising comprises adding an additional issuance characteristic.

15. The system of claim 11, wherein the processor is further operable to transact a transaction corresponding to the long or short position using a smart contract deployed on a blockchain.

16. The system of claim 11, wherein the processor is further operable to maintain a viability of the prompting for a pre-determined period of time.

17. The system of claim 11, wherein processor is operable to prompt a selected group of users.

18. The system of claim 17, wherein each of the selected group of users is identified in the request to transact a short position or a long position.

19. The system of claim 18, wherein the processor is further operable to make a market in a metric related to the performance of the selected aspect of the larger entity, the processor operable to present, to the selected group of users a market bid price and a market offer price for the metric.

20. The system of claim 1, wherein the processor is further operable to post a tradeable option, said tradeable option being based, at least in part, on the performance of the selected aspect of the larger entity.
